(19) United States
(12) Patent Application Publication
(10) Pub. No.: US 2008/0027635 A1
(43) Pub. Date: Jan. 31, 2008

(54) Vehicle navigation system

(75) Inventors: Steve Tengler, Gross Pointe Park, MI (US); Mark Frye, Grosse Pointe Woods, MI (US)

Correspondence Address: GLOBAL IP COUNSELORS, LLP, 1233 20TH STREET, NW, SUITE 700, WASHINGTON, DC, 20036-2680, US

(73) Assignee: Nissan Technical Center North America, Inc., Farmington Hills, MI (US)

(21) Appl. No.: 11/494,474

(22) Filed: Jul. 28, 2006

(51) Int. Cl. G01C 21/34

(52) U.S. Cl. 701/209; 701/202; 340/995.19

(57) ABSTRACT

A vehicle navigation system includes a vehicle route information display device having a travel route information presenting section, a user input receiving section, an image downloading section and an image displaying section. The travel route information presenting section is configured to present a user with a travel route of a host vehicle from a starting position to a destination position and point of interest data associated with the travel route. The user input receiving section is configured to receive a user selection input selecting a photographic image associated with the point of interest data to be viewed. The image downloading section is configured to wirelessly download the photographic image from an external server in response to the user selection input. The image displaying section is configured to selectively display the photographic image in response to a user display input selecting display of the photographic image.

### BACKGROUND OF THE INVENTION

1. Field of the Invention

The present invention generally relates to a vehicle navigation system. More specifically, the present invention relates to a vehicle navigation system in which photographic images of point of interests that exist along a travel route are selectively displayed in response to user's inputs.

2. Background Information

Recently, vehicles are being equipped with a variety of informational systems such as navigation systems, Sirius and XM satellite radio systems, two-way satellite services, built-in cell phones, DVD players and the like. These systems are sometimes interconnected for increased functionality. Various informational systems have been proposed that use wireless communications between vehicles and between infrastructures, such as roadside units. These wireless communications have a wide range of applications ranging from crash avoidance to entertainment systems. The type of wireless communications to be used depends on the particular application. Some examples of wireless technologies that are currently available include digital cellular systems, Bluetooth systems, wireless LAN systems and dedicated short range communications (DSRC) systems.

Dedicated short range communications (DSRC) is an emerging technology that has been recently investigated for suitability in vehicles for a wide range of applications. DSRC technology will allow vehicles to communicate directly with other vehicles and with roadside units to exchange a wide range of information. In the United States, DSRC technology will use a high frequency radio transmission (5.9 GHz) that offers the potential to effectively support wireless data communications between vehicles, and between vehicles, roadside units and other infrastructure. The important feature of DSRC technology is that the latency time between communications is very low compared to most other technologies that are currently available. Another important feature of DSRC technology is the capability of conducting both point-to-point wireless communications and broadcast wireless messages in a limited broadcast area.

One example of the applications of wireless communications in the vehicle informational system is the off-board dynamic navigation. In the off-board dynamic navigation system, a desired destination entered by a user through HMI (human-machine interface) of a vehicle on-board unit is transmitted to an external navigation server through wireless communications, and the navigation guidance service is derived from the external navigation server which functions as a driving route assistance service information center. The wireless system of the vehicle on-board unit receives a route calculate result from the external service server and the navigation service including map display and/or route to destination is received through the HMI of the vehicle on-board unit such as a display or audio. In such off-board dynamic navigation system, the external service server receives the initial destination (e.g., address, point of interest) from the vehicle on-board unit via some mode of wireless communication (e.g., cellular, WiMax, WiFi, DSRC) and provides an initial heading. As the vehicle passes a roadside unit, the vehicle on-board unit receives updated route instructions based upon the latest external data (e.g., traffic, construction) transmitted from the external service server. Thus, the off-board dynamic navigation system makes it possible to always have the latest map information and the most suitable route guidance information. Moreover, the large-capacity storage device that is required for a conventional on-board navigation equipment is not needed when the external service server is used for providing the navigation service.

However, the graphical displays of the map and/or route to the destination in the HMI of the conventional navigation system are often provided with a simple grid or map illustrating various roads, street and intersections without sufficient identifiers. Therefore, at some intricate intersections or highway junctions, the crude map displayed in the navigation system is of little help or even confusing to the driver.

In order to provide accurate visual information to a driver, a vehicle navigation system has been proposed in U.S. Pat. No. 6,182,010 which a photograph of a given location (e.g., an intersection) is retrieved and automatically displayed on a display screen of the navigation system as the vehicle approaches the given location. By displaying the photograph of the location, the navigation system can provide a user with an actual representation of what physical landmarks are coming into the user's field of vision. However, in the navigation system disclosed in this reference, the user can select neither which landmarks or locations the user would like to see photographs of, nor when the photographs are displayed. Thus, the navigation system may unnecessarily display the photographs of the locations the user is already familiar with, or of the locations the user is not interested in. Nevertheless, since the navigation system automatically displays the photograph of the given location when the vehicle approaches the given location, the user may be inadvertently distracted by the display while driving the vehicle.

In view of the above, it will be apparent to those skilled in the art from this disclosure that there exists a need for an improved vehicle navigation system. This invention addresses this need in the art as well as other needs, which will become apparent to those skilled in the art from this disclosure.

### SUMMARY OF THE INVENTION

One object of the present invention is to provide a vehicle navigation system in which satellite images of point of interests that exist along a travel route are selectively displayed in response to user's inputs.

In accordance with one aspect of the present invention, a vehicle route information display device is provided that includes a travel route information presenting section, a user input receiving section, an image download section and an image displaying section. The travel route information presenting section is configured to present a user with a travel route of a host vehicle from a starting position to a destination position and point of interest data associated with the travel route. The user input receiving section is configured to receive a user selection input selecting a photographic image associated with the point of interest data to be viewed. The image downloading section is configured to wirelessly send a download request and wirelessly download the photographic image from an external server in response to the user selection input received by the user input receiving section. The image displaying section is configured to selectively display the photographic image that was downloaded in response to a user display input received by the user input receiving section selecting display of the photographic image that was downloaded.

In accordance with another aspect of the present invention, a route information providing system is provided that includes a travel route information sending section, an image download request receiving section and an image sending section. The travel route information sending section is configured to wirelessly send a travel route of a host vehicle from a starting position to a destination position and point of interest data associated with the travel route to a vehicle route information display device mounted on the host vehicle. The image download request receiving section is configured to wirelessly receive a download request from the vehicle route information display device selecting a photographic image associated with the point of interest data to be viewed. The image sending section is configured to wirelessly send the photographic image of the at least one point of interest to be viewed to the vehicle route information display device in response to the downloaded request received by the user request receiving section.

In accordance with another aspect of the present invention, a vehicle navigation system is provided that includes a host vehicle, an external server and a plurality of roadside units. The host vehicle has a vehicle route information display device that includes a travel route information presenting section, a user input receiving section, an image downloading section and an image displaying section. The travel route information presenting section is configured to present a user with a travel route of the host vehicle from a starting position to a destination and point of interest data associated with the travel route. The user input receiving section is configured to receive a user selection input selecting a photographic image associated with the point of interest data to be viewed. The image downloading section is configured to wirelessly send a download request and wirelessly download the photographic image in response to the user selection input received by the user input receiving section. The image displaying section is configured to selectively display the photographic image that was downloaded in response to a user display input received by the user input receiving section selecting display of the photographic image that was downloaded. The external server includes a travel route information sending section, an image download request receiving section and an image sending section. The travel route information sending section is configured to wirelessly send the point of interest data to the vehicle route information display device. The image download request receiving section is configured to wirelessly receive the download request from the vehicle route information display device. The image sending section is configured to wirelessly send the photographic image to the vehicle route information display device in response to the downloaded request received by the user request receiving section. The roadside units are configured to relay wireless communications between the vehicle route information display device and the external server when the host vehicle stays within a communication area of any one of the roadside units.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a pictorial representation of a two-way wireless communications network showing a vehicle equipped with an on-board unit capable of conducting two-way wireless communications with an external server via a plurality of roadside units in a vehicle navigation system in accordance with the present invention;

FIG. 2 is a schematic representation of a vehicle that is equipped with the on-board unit for conducting two-way wireless communications in the vehicle navigation system in accordance with the present invention;

FIG. 3 is a pictorial representation of the two-way wireless communications network showing the vehicle communicating with the external server via the roadside unit in the vehicle navigation system in accordance with the present invention;

FIG. 4 is an inside elevational view of a portion of the vehicle's interior that is equipped with the on-board unit for conducting two-way wireless communications in the vehicle navigation system in accordance with the present invention;

FIG. 5 is a flowchart illustrating a flow of control executed in the on-board unit and the external server of the vehicle navigation system in accordance with the present invention;

FIG. 6 is a pictorial representation of a travel route information screen display of a human-machine interface section of the on-board unit in accordance with the present invention;

FIG. 7 is a pictorial representation of a satellite image download screen display of the human-machine interface section of the on-board unit in accordance with the present invention;

FIG. 8 is a pictorial representation of a communication mode selecting screen display of the human-machine interface section of the on-board unit in accordance with the present invention;

FIG. 9 is a pictorial representation of a satellite image selecting screen display of the human-machine interface section of the on-board unit in accordance with the present invention;

FIG. 10 is a pictorial representation of a satellite image displayed in the human-machine interface section of the on-board unit in response to the user's display input in accordance with the present invention; and

FIG. 11 is a flowchart illustrating a flow of control executed in the on-board unit and the external server of the vehicle navigation system in accordance with an alternate embodiment of the present invention.

### DETAILED DESCRIPTION OF THE PREFERRED EMBODIMENTS

Selected embodiment of the present invention will now be explained with reference to the drawings. It will be apparent to those skilled in the art from this disclosure that the following description of the embodiment of the present invention is provided for illustration only and not for the purpose of limiting the invention as defined by the appended claims and their equivalents.

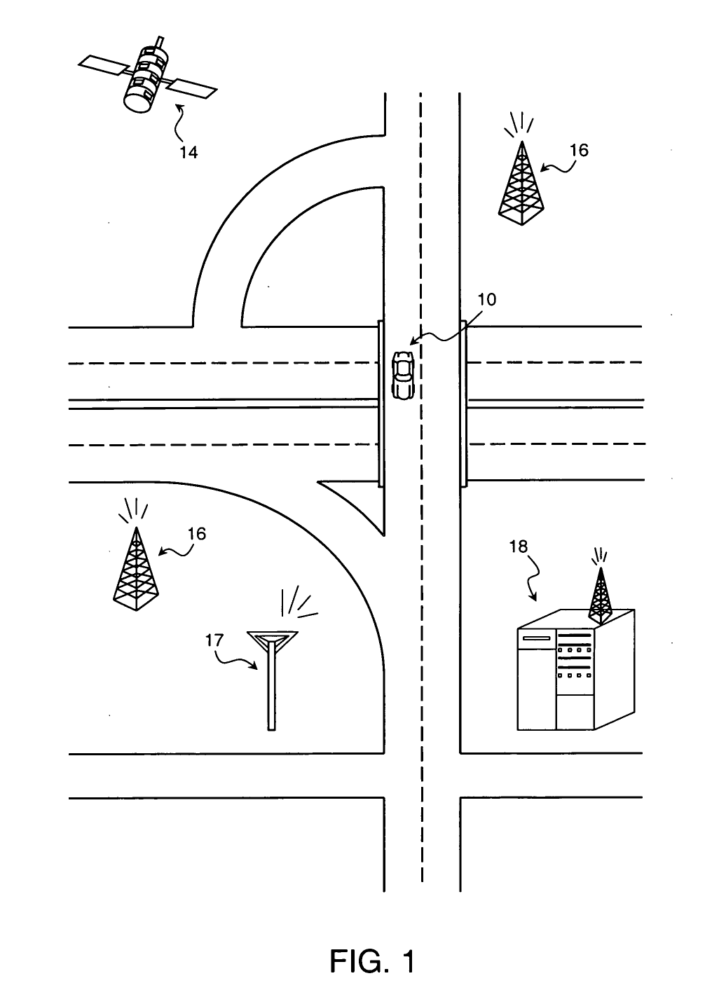

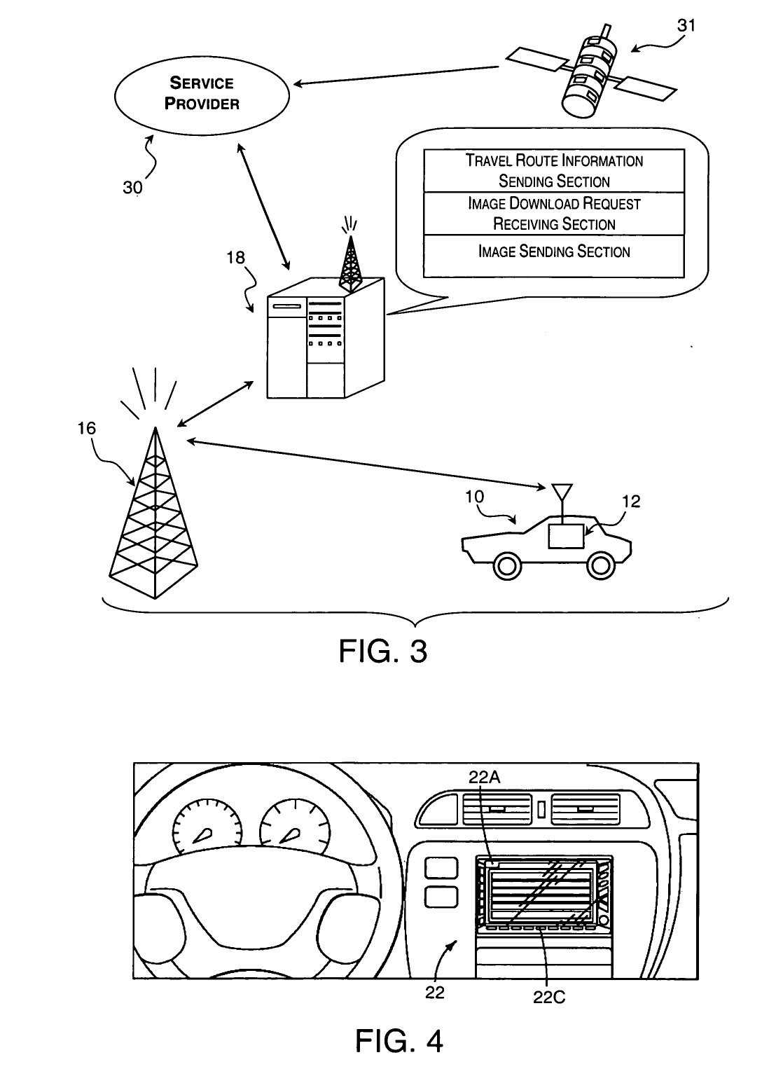

Referring initially to FIGS. 1 to 3, a two-way wireless communications network is illustrated that forms a vehicle navigation system in accordance with one embodiment of the present invention. In this vehicle navigation system, a host vehicle 10 is equipped with a vehicle on-board unit 12 (vehicle route information display device) in accordance with one embodiment of the present invention. The two-way wireless communications network also includes one or more global positioning satellites 14 (only one shown), one or more roadside units 16 (two shown) and an external server 18 (route information providing system). As seen in FIG. 3, the external server 18 is configured and arranged to communicate with the vehicle on-board unit 12 to provide the off-board navigation service through wireless communications via the roadside units 16 within the two-way wireless communications network. In particular, the roadside units 16 (two shown) relays signals between the vehicle on-board unit 12 of the host vehicle 10 and the external server 18.

In the preferred embodiment, the vehicle on-board unit 12 of the host vehicle 10 is a dedicated short range communications (DSRC) on-board unit that can communicate with the roadside units 16 within the two-way wireless communications network. Thus, the roadside units 16 are configured and arranged with DSRC equipment that sends and receives signals to and from the host vehicle 10. More specifically, each of the roadside units 16 is equipped with a DSRC unit for broadcasting and receiving signals to the host vehicle 10 located with a prescribed communication (broadcasting/receiving) region or area surrounding the roadside units 16. Moreover, each of the roadside units 16 is preferably an IP enabled structure that is configured and arranged to establish a link between the vehicle on-board unit 12 of the host vehicle 10 and the external server 18 as illustrated in FIG. 3. Such DSRC units for the roadside units 16 can be conventional equipment that is known in the art. Since the roadside units 16 can be equipment that is known in the art, the structures of the roadside units 16 will not be discussed or illustrated in detail herein. Rather, it will be apparent to those skilled in the art from this disclosure that the equipment of the roadside units 16 can be any type of structure that can be used to carry out the present invention.

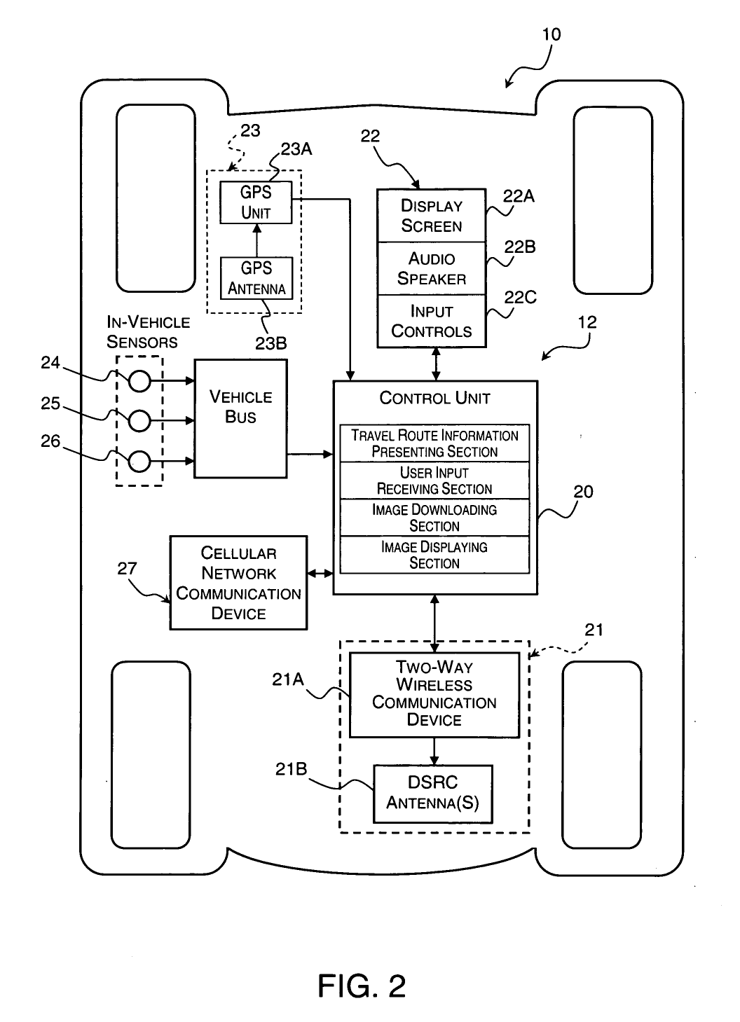

In the present invention, the host vehicle 10 is preferably configured and arranged to also transmit and receive signals from the external server 18 through a cellular network. As seen in FIG. 2, the vehicle 10 is preferably equipped with a cellular network communication device 27 that is configured to establish a wireless link with the external server 18 via one of a plurality of cellular base stations 17 (only one shown in FIG. 1). Such cellular network communication device 27 and cellular units for the base stations 17 can be conventional equipments that are known in the art. Since the cellular network communication device 27 and the base stations 17 can be equipments that are known in the art, the structures of these components will not be discussed or illustrated in detail herein. Rather, it will be apparent to those skilled in the art from this disclosure that the equipment of the cellular network communication device 27 and the base stations 17 can be any type of structures that can be used to carry out the present invention.

The external server 18 is a central service server that is preferably configured and arranged to provide various services to the vehicle on-board unit 12 through the wireless connections. One of the services provided by the external server 18 is the off-board dynamic navigation service that will be discussed in more detail below. The external server 18 is also capable of establishing links with a plurality of service providers 30 (only one shown in FIG. 3) through the Internet or the like. In the preferred embodiment of the present invention, the external server 18 is configured and arranged to receive data from the service provider 30 that provides satellite pictures of requested locations taken by a satellite 31.

As seen in FIG. 2, the vehicle on-board unit 12 of the present invention basically includes a controller or control unit 20, a two-way wireless communication system 21 (a short range wireless communication section) and a human-machine interface section 22. The two-way wireless communication system 21 is configured and arranged such that the control unit 20 receives and/or sends various signals to other DSRC equipped component and systems in the communication (broadcasting/receiving) area that surrounds the host vehicle 10. The human-machine interface section 22 includes a display screen 22A, an audio speaker 22B and input controls 22C that are operatively coupled to the control unit 20. The control unit 20 is also preferably coupled to a global positioning system 23 having a GPS unit 23A and a GPS antenna 23B. Moreover, the control unit 20 of the vehicle on-board unit 12 is configured to receive detection signals from various in-vehicle sensors including, but not limited to, an ignition switch sensor 24, a vehicle speed sensor 25, an acceleration sensor 26, etc. The control unit 20 is also preferably operatively coupled to the cellular network communication device 27.

The control unit 20 preferably includes a microcomputer with a travel route information display program. The control unit 20 also preferably includes other conventional components such as an input interface circuit, an output interface circuit, and storage devices such as a ROM (Read Only Memory) device and a RAM (Random Access Memory) device. The memory circuit stores processing results and control programs such as ones for operation of the two-way wireless communication system 21, the human-machine interface section 22, the global positioning system 23 that are run by the processor(s). The control unit 20 is capable of selectively controlling other DSRC components of the host vehicle 10 such as other safety systems as needed and/or desired. It will be apparent to those skilled in the art from this disclosure that the precise structure and algorithms for the control unit 20 can be any combination of hardware and software that will carry out the functions of the present invention.

The two-way wireless communication system 21 preferably includes communication interface circuitry that connects and exchanges information with a plurality of vehicles that are similarly equipped as well as with the roadside units 16 through a wireless network within the broadcast range of the host vehicle 10. The two-way wireless communication system 21 is preferably configured and arranged to conduct direct two-way communications between vehicles (vehicle-to-vehicle communications) and roadside units (roadside-to-vehicle communications). Moreover, the two-way wireless communication system 21 is preferably configured to periodically broadcast a signal in the broadcast area.

More specifically, as seen in FIG. 2, the two-way wireless communication system 21 is an on-board unit that includes a host vehicle two way communication device 21A and one or more antennas 21B. Preferably, the two-way wireless communication system 21 has both an omni-directional antenna and a multi-directional antenna. The host vehicle two way communication device 21A is configured to conduct direct short range communications in a host vehicle broadcast area surrounding the host vehicle 10 via the antennas 21B. In particular, the two-way wireless communication system 21 is preferably a dedicated short range communication (DSRC) system, since the latency time between communications is very low compared to most other technologies that are currently available. However, other two-way wireless communication systems can be used if they are capable of conducting both point-to-point wireless communications and broadcast wireless messages in a limited broadcast area so long as the latency time between communications is short enough to carry out the present invention. When the two-way wireless communication system 21 is a DSRC system, the two-way wireless communication system 21 will transmit at a 75 Mhz spectrum in a 5.9 GHz band with a data rate of 1 to 54 Mbps, and a maximum range of about 1,000 meters. Preferably, the two-way wireless communication system 21 includes seven (7) non-overlapping channels. The two-way wireless communication system 21 will be assigned a Medium Access Control (MAC) address and/or an IP address so that each vehicle in the network can be individually identified.

The global positioning system 23 is a conventional global positioning system (GPS) that is configured and arranged to receive global positioning information of the host vehicle 10 in a conventional manner. Basically, the global positioning system 22 includes a GPS unit 23A that is a receiver for receiving a signal from the global positioning satellite 14 (FIG. 1) via a GPS antenna 22B. The signal transmitted from the global positioning satellite 14 is received at regular intervals (e.g. one second) to detect the present position of the host vehicle 10. The GPS unit 22A preferably has an accuracy of indicting the actual vehicle position within a few meters or less. This data (present position of the host vehicle) is fed to the control unit 20 for processing. Moreover, the GPS data is also transmitted to the external server 18 through wireless communications for the off-board navigation processing.

As mentioned above, in this embodiment of the present invention, the external server 18 functions as a navigation server that provides the off-board dynamic navigation service to the host vehicle 10 through wireless communications. The external server 18 stores a road map data as well as point of interest data that can be associated with the road map data. The point of interest data includes, but not limited to, various landmark data, parking lot data, restaurants, major intersections etc. The user of the vehicle on-board unit 12 receives the off-board dynamic navigation service from the external server 18 through the human-machine interface section 22. More specifically, upon the user inputting the desired destination (e.g., address, point of interest, etc.) by operating the input controls 22C of the human-machine interface section 22, the desired destination is sent to the external server 18 through wireless communications as well as a current position of the host vehicle 10 based on the GPS information. The external server 18 calculates a travel route from the current position to the destination position, and sends an initial heading to the vehicle on-board unit 12 of the host vehicle 10. As the host vehicle 10 travels and passes the neighboring roadside unit 16, the vehicle on-board unit 12 receives updated route instructions from the external server 18 based upon the latest external data (e.g., traffic, construction) through the two-way wireless communication system 21. The signals transmitted from the global positioning satellites 14 are utilized to guide the host vehicle 10 through the off-board navigation control executed in the external server 18 in a conventional manner.

Moreover, in the preferred embodiment of the present invention, upon calculating the travel route from the current position of the host vehicle 10 to the destination position, the external server 18 is configured to determine the point of interest data associated with the travel route based on the stored database. The point of interest data preferably includes information of at least one point of interest (e.g., major intersections, parking lots, landmarks, area around the destination position etc.) that exists along the travel route. The vehicle on-board unit 12 receives the travel route and the point of interest data associated with the travel route from the external server 18 through wireless communications. Then, user is provided with an option for selectively downloading and viewing satellite images of point of interests that exist along the travel route. Thus, with the present invention, the external server 18 can provide a choice to the user of viewing the satellite pictures of the points of interest along the travel route, which might be advantageous for scouting parking, identifying nearby landmarks, or simply gaining visual familiarity of an unknown destination.

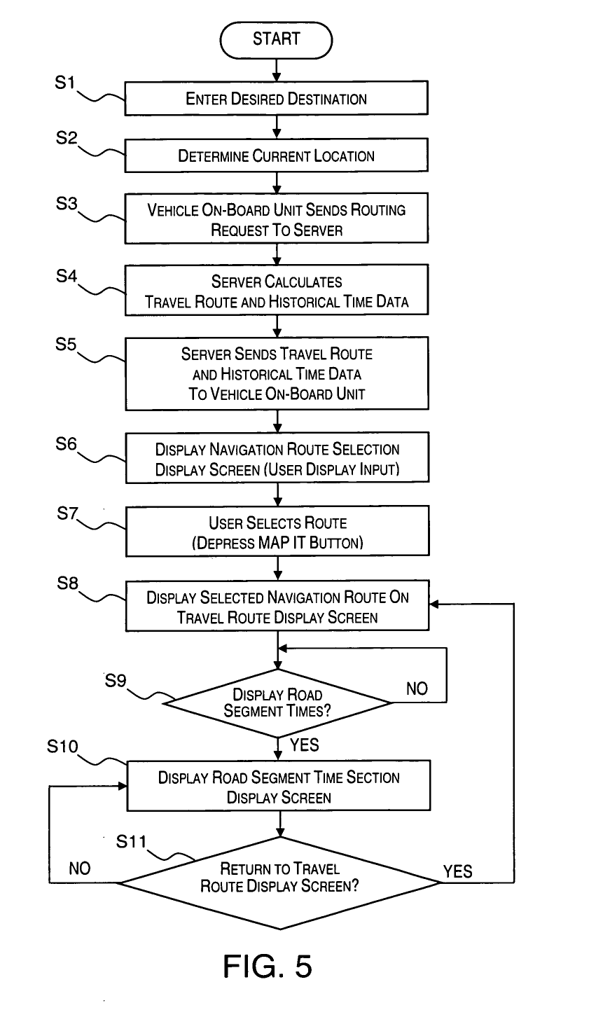

Referring now to a flowchart of FIG. 5, a control executed in the external server 18 and the vehicle on-board unit 12 in the vehicle navigation system in accordance with one embodiment of the present invention will be explained.

The user of the vehicle on-board unit 12 first turns on the human-machine interface section 22 and enters a desired destination position (step S1). The current location of the host vehicle 10 is determined based on the GPS information from the GPS system 23 (step S2). The entered destination position and the determined current location are transmitted to the external server 18 as a routing request through available wireless communications between the vehicle on-board unit 12 and the external server 18 (e.g., DSRC, cellular, Wimax, Wifi, etc.) (step S3). Upon receiving the routing request from the vehicle on-board unit 12, the external server 18 is configured to calculate a travel route from the current location of the host vehicle 10 to the destination position, and to determine the point of interest data associated with the travel route based on the stored database (step S4). Then, the external server 18 is configured to send the calculated travel route and the point of interest data to the vehicle on-board unit 12 through the available wireless communications (step S5). At this step in the process, a satellite image of the destination can be automatically sent with the calculated travel route and the point of interest data, since the user will most likely desire an image of the destination. Step S5 corresponds to a travel route information sending section of the external server 18 in accordance with the present invention.

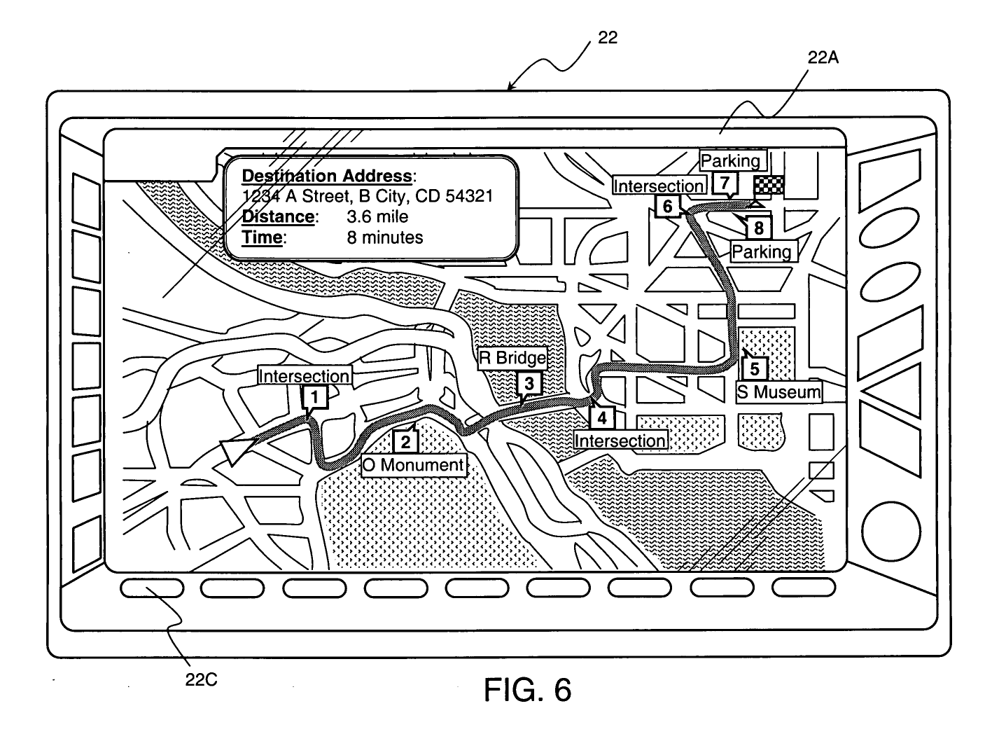

FIG. 6 is a pictorial representation of the display screen 22A in which the point of interest data associated with the travel route is displayed when the vehicle on-board unit 12 receives the travel route and the point of interest data from the external server 18. As seen in FIG. 6, the control unit 20 is preferably configured to display the point of interest data so that the user can visually recognize where the points of interest are located along the travel route. In the illustrated example, information of eight points of interest and information of area around the destination are included in the point of interest data received from the external server 18. Those points of interest include major intersections and landmarks (e.g., monument, bridge, museum, etc.) that exist along the travel route, and parking lots that exist near the destination position. This processing corresponds to a travel route information presenting section of the vehicle on-board unit 12 in accordance with the present invention.

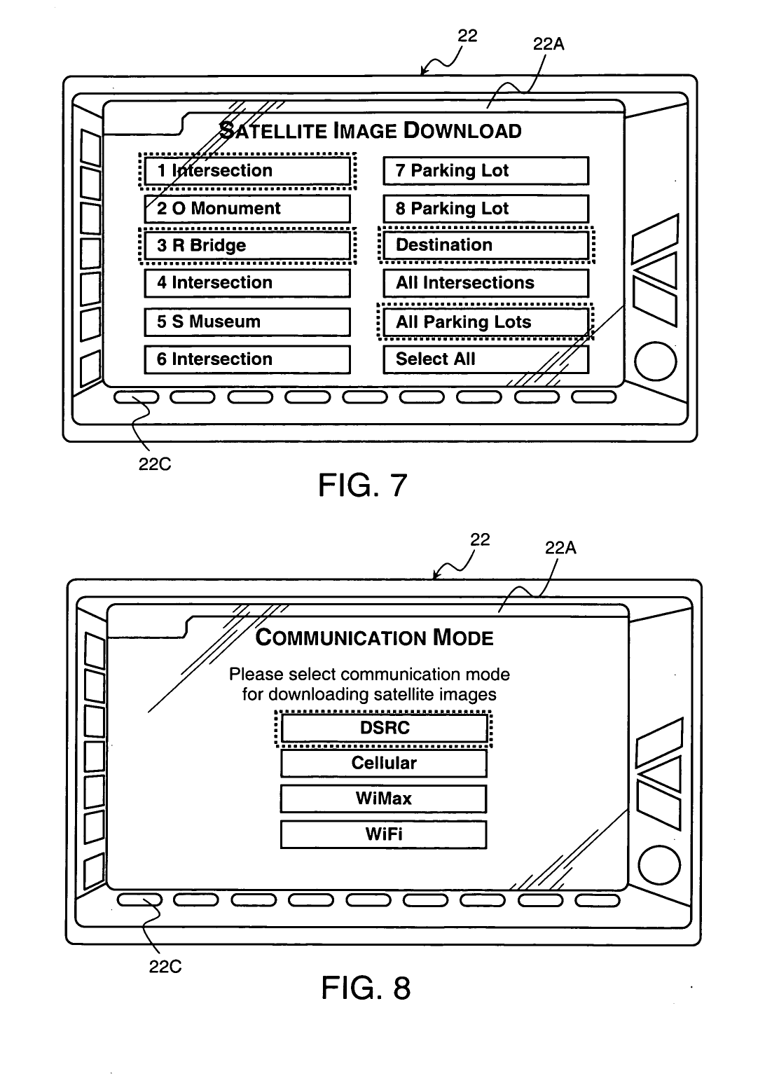

After the vehicle on-board unit 12 presents the travel route and the point of interest data to the user as shown in FIG. 6, the user is provided with an option for selecting a satellite image or satellite images of the points of interest that the user wishes to view. FIG. 7 is a pictorial representation of the display screen 22A for prompting a user selection input selecting the points of interest of which the user wishes to download the satellite images. The user can select one or more of the satellite images to be downloaded by operating the input controls 22C or simply by touching appropriate positions on the screen when the display screen 22A is arranged as a touch screen. This processing corresponds to a user input receiving section of the vehicle on-board unit 12 in accordance with the present invention.

When the user selects the satellite images to be downloaded, the user is preferably provided with an option for choosing a communication mode used for downloading the satellite images. FIG. 8 is a pictorial representation of the display screen 22A for prompting the user to select one of available communication modes for downloading the satellite images. The user can select the communication mode for downloading the satellite images by operating the input controls 22C or simply by touching appropriate positions on the screen when the display screen 22A is arranged as a touch screen. In this example, the DSRC is selected by the user as the communication mode for downloading the satellite images. Alternatively, the vehicle on-board unit 12 can be configured and arranged to set a default communication mode based on a prescribed condition (e.g., the presently available communication mode with the lowest latency, the least expensive communication mode, etc.).

Referring back to the flowchart of FIG. 5, in response to the user selection input, the vehicle on-board unit 12 is configured to send a download request containing the information of the requested satellite images and the selected communication mode to the external server 18 (step S6). Step S6 corresponds to an image download request receiving section of the external server 18 in accordance with the present invention. The external server 18 is then configured to send a download request for the requested satellite images to the service provider 30 and to receive the satellite image data from the service provider 30 (step S7). The external server 18 is configured to queue the satellite images received from the service provider 30 to send them to the vehicle on-board unit 12 via the selected communication mode. Of course, the need to request the satellite images from the service provider 30 could be eliminated if the satellite images were stored on the external server 18. Since the DSRC is selected in this example, the vehicle on-board unit 12 is configured to receive the satellite images from the external server 18 from the neighboring roadside unit 16 (step S8). Step S8 corresponds to an image sending section of the external server 18 in accordance with the present invention. When the vehicle on-board unit 12 downloads the satellite images from the external server 18 via the neighboring roadside unit 16, the control unit 20 is configured to notify the user that the satellite images have been downloaded and to display an image display screen that prompts a user display input selecting the display of the satellite image. This processing corresponds to an image downloading section of the vehicle on-board unit 12 in accordance with the present invention.

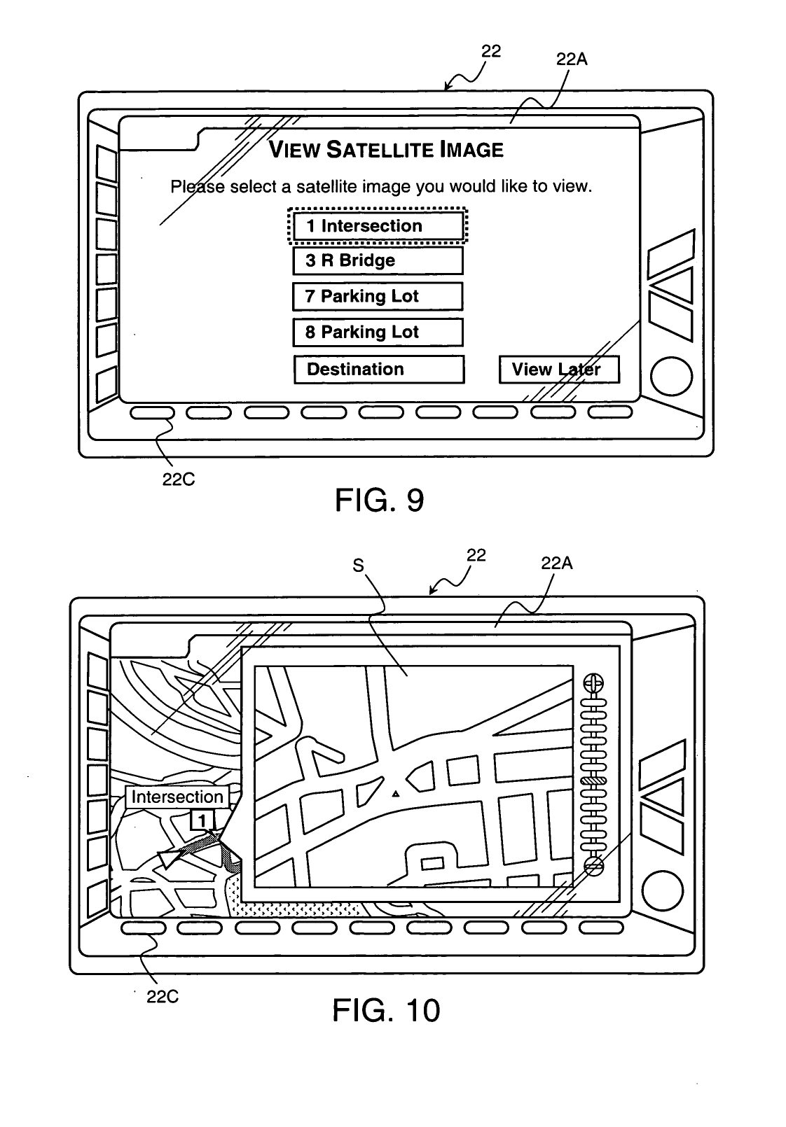

FIG. 9 is a pictorial representation of the display screen 22A that prompts the user display input to select display of the satellite image of the points of interest that were downloaded. The user can select the satellite image to be viewed by operating the input controls 22C or simply by touching appropriate positions on the screen when the display screen 22A is arranged as a touch screen. Upon receiving the user display input, a selected satellite image S is displayed in the color display screen 22A as shown in FIG. 10. This processing corresponds to an image displaying section of the vehicle on-board unit 12 in accordance with the present invention. The control unit 20 is preferably configured and arranged to allow the user to zoom in and out the displayed satellite image by operating the input controls 22C or simply by touching appropriate positions on the screen when the display screen 22A is arranged as a touch screen.

Alternatively, the vehicle on-board unit 12 can be configured and arrange to wait before the user display input is prompted so that the satellite image can be displayed in an appropriate timing which might permit extended driver attention. More specifically, the processing for checking whether a display condition is satisfied or not (step S10) can be inserted after the satellite images are downloaded (step S8) and before the user display input is prompted (step S9) as shown with the dotted arrows in FIG. 5. The display condition is satisfied, for example, when a vehicle speed is continuously under a prescribed speed (e.g., 5 mph) for a prescribed period of time, when the host vehicle 10 is parked, and/or when the host vehicle 10 is in neutral under a specific speed. The determination as to whether the display condition is satisfied may be made based on the detection results from the in-vehicle sensors. In such case, the user may be notified by a human-machine interface alert (such as an audible tone or haptic vibration) that the satellite images are ready to be viewed when the display condition is satisfied.

Although the vehicle navigation system utilizes the off-board dynamic navigation system using the external server 18 as the navigation server in the embodiment described above, the present invention is not limited to such arrangement. More specifically, the host vehicle 10 may be provided with a conventional on-board navigation system with route guiding function and a stored map data instead of receiving map and route information from the off-board navigation system. In such case, the vehicle on-board unit 12 preferably sends the travel route calculated by the on-board navigation system to the external server 18 via wireless communications, and the external server 18 preferably determines and sends the point of interest data associated with the travel route received from the vehicle on-board unit 12. The remaining processing will be the same as the processing as explained above.

Accordingly, with the vehicle navigation system of the present invention, which satellite images are downloaded and when the satellite images are displayed are determined in response to the user inputs. Therefore, the user can select the desired satellite images of the points of the interest along the travel route to be viewed, and the user can view the downloaded satellite image in an appropriate timing. Thus, displaying undesired satellite images can be prevented, and the satellite images are displayed in a manner that better conforms to the user's needs.

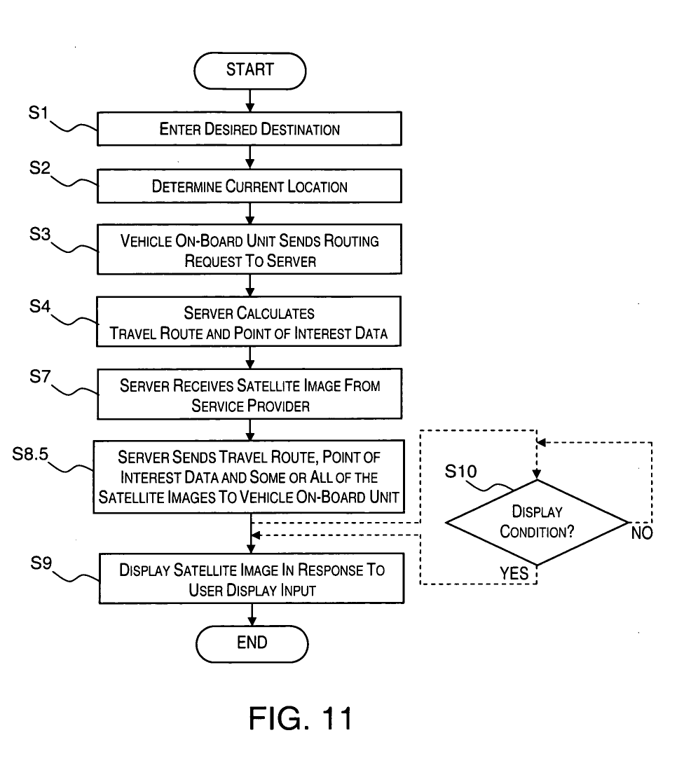

Referring now to FIG. 11, an alternate process for the vehicle navigation system of the present invention will now be discussed. The basic constituent features of the vehicle navigation system are the same as those shown in FIGS. 1 to 4. However, the control processing has been modified from that of FIG. 5 to the control processing of FIG. 11. The control processing executed in steps S1 to S4, S7, S9 and S10 are the same for the control processing of FIGS. 5 and 11. However, the control processing executed in steps S5, S6 and S8 of FIG. 11 has been replaced with the control processing executed in step S8.5 of FIG. 11. In particular, instead of only downloading the points of interests selected in response to the user selection input, all of the photographic images of points of interest are sent at the same time as sending the travel route in step S8.5. When the vehicle on-board unit 12 downloads all of the satellite images from the external server 18 via the neighboring roadside unit 16, the control unit 20 is configured to notify the user that the satellite images have been downloaded and to selectively display an image display screen that prompts a user display input for selecting the satellite image(s) to be displayed.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward, rearward, above, downward, vertical, horizontal, below and transverse” as well as any other similar directional terms refer to those directions of a vehicle equipped with the present invention. Accordingly, these terms, as utilized to describe the present invention should be interpreted relative to a vehicle equipped with the present invention. The term “detect” as used herein to describe an operation or function carried out by a component, a section, a device or the like includes a component, a section, a device or the like that does not require physical detection, but rather includes determining, measuring, modeling, predicting or computing or the like to carry out the operation or function. The term “configured” as used herein to describe a component, section or part of a device includes hardware and/or software that is constructed and/or programmed to carry out the desired function. The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle route information display device comprising:
a travel route information presenting section configured to present a user with a travel route of a host vehicle from a starting position to a destination position and point of interest data associated with the travel route;
a user input receiving section configured to receive a user selection input selecting a photographic image associated with the point of interest data to be viewed;
an image downloading section configured to wirelessly send a download request and wirelessly download the photographic image from an external server in response to the user selection input received by the user input receiving section; and
an image displaying section configured to selectively display the photographic image that was downloaded in response to a user display input received by the user input receiving section selecting display of the photographic image that was downloaded.

2. The vehicle route information display device as recited in claim 1, wherein
the image displaying section is further configured to display the photographic image when a speed of the host vehicle is less than a prescribed speed.

3. The vehicle route information display device as recited in claim 1, wherein
the image downloading section is configured to wirelessly download a satellite image as the photographic image.

4. The vehicle route information display device as recited in claim 1, wherein
the travel route information presenting section is configured to wirelessly download the travel route and the point of interest data from the external server.

5. The vehicle route information display device as recited in claim 1, wherein
the travel route information presenting section is further configured to set the starting position based on a current position of the host vehicle detected by a GPS unit mounted on the host vehicle.

6. The vehicle route information display device as recited in claim 1, wherein
the travel route information presenting section is configured to present information on a major intersection that exists along the travel route as the information on the point of interest data.

7. The vehicle route information display device as recited in claim 1, wherein
the travel route information presenting section is configured to present information on a parking lot that exists near the destination position as the information on the point of interest data.

8. The vehicle route information display device as recited in claim 1, wherein
the travel route information presenting section is configured to present information on a landmark that exists along the travel route as the information on the point of interest data.

9. The vehicle route information display device as recited in claim 1, wherein
the user input receiving section is configured to receive the user selection input selecting a plurality of photographic images associated with the point of interest data to be viewed,
the image downloading section is configured to wirelessly send the download request and wirelessly download the photographic images from the external server in response to the user selection input received by the user input receiving section, and
the image displaying section configured to selectively display the photographic images that were downloaded in response to the user display input received by the user input receiving section selecting display of the photographic images that were downloaded.

10. The vehicle route information display device as recited in claim 9, wherein
the travel route information presenting section is configured to present information on a plurality of major intersections that exist along the travel route as the point of interest data.

11. The vehicle route information display device as recited in claim 9, wherein
the travel route information presenting section is configured to present information on a plurality of parking lots that exist near the destination position as the point of interest data.

12. The vehicle route information display device as recited in claim 9, wherein
the travel route information presenting section is configured to present information on a plurality of landmarks that exist along the travel route as the point of interest data.

13. A route information providing system comprising:
a travel route information sending section configured to wirelessly send a travel route of a host vehicle from a starting position to a destination position and point of interest data associated with the travel route to a vehicle route information display device mounted on the host vehicle;
an image download request receiving section configured to wirelessly receive a download request from the vehicle route information display device selecting a photographic image associated with the point of interest data to be viewed; and
an image sending section configured to wirelessly send the photographic image to the vehicle route information display device in response to the download request received by the user request receiving section.

14. The route information providing system as recited in claim 13, wherein
the image sending section is further configured to wirelessly receive a satellite image associated with the point of interest data to be viewed from an external service provider, and to send the satellite image that was received to the vehicle route information display device as the photographic image.

15. The route information providing system as recited in claim 13, wherein
the travel route sending section is configured to send information on a major intersection that exists along the travel route as the point of interest data.

16. The route information providing system as recited in claim 13, wherein
the travel route sending section is configured to send information on a parking lot that exists near the destination position as the point of interest data.

17. The route information providing system as recited in claim 13, wherein
the travel route sending section is configured to send information on a landmark that exists along the travel route as the point of interest data.

18. A vehicle navigation system comprising:
a host vehicle having a vehicle route information display device including
a travel route information presenting section configured to present a user with a travel route of the host vehicle from a starting position to a destination and point of interest data associated with the travel route,
a user input receiving section configured to receive a user selection input selecting a photographic image associated with the point of interest data to be viewed,
an image downloading section configured to wirelessly send a download request and wirelessly download the photographic image in response to the user selection input received by the user input receiving section, and
an image displaying section configured to selectively display the photographic image that was downloaded in response to a user display input received by the user input receiving section selecting display of the photographic image that was downloaded;
an external server including
a travel route information sending section configured to wirelessly send the point of interest data to the vehicle route information display device,
an image download request receiving section configured to wirelessly receive the download request from the vehicle route information display device, and
an image sending section configured to wirelessly send the photographic image to the vehicle route information display device in response to the downloaded request received by the user request receiving section; and
a plurality of roadside units configured to relay wireless communications between the vehicle route information display device and the external server when the host vehicle stays within a communication area of any one of the roadside units.

19. The vehicle navigation system as recited in claim 18, wherein
the travel route information sending section of the external server is configured to calculate the travel route based on the starting position and the destination position wirelessly received from the vehicle route information display device and to determine the point of interest data associated with the travel route, and
the travel route information presenting section of the vehicle route information display device of the host vehicle is configured to wirelessly download the travel route and the point of interest data from the external server.

20. The vehicle route information display device as recited in claim 1, wherein
the image sending section of the external server is further configured to wirelessly receive a satellite image associated with the point of interest data to be viewed from an external service provider, and to send the satellite image that was received to the vehicle route information display device of the host vehicle as the photographic image.
